(19) United States
(12) Patent Application Publication
(10) Pub. No.: US 2012/0162101 A1
(43) Pub. Date: Jun. 28, 2012

(54) CONTROL SYSTEM AND CONTROL METHOD

(75) Inventors: Chen-Hwa Song, Taipei City (TW); Ching-Sung Li, Hualien County (TW); Hao-Yang Jian, New Taipei City (TW)

(73) Assignee: INDUSTRIAL TECHNOLOGY RESEARCH INSTITUTE, Hsinchu (TW)

(21) Appl. No.: 13/104,979

(22) Filed: May 11, 2011

(30) Foreign Application Priority Data
Dec. 28, 2010 (TW) 99146383

(51) Int. Cl. G09G 5/00; G06F 3/041

(52) U.S. Cl. 345/173; 345/156

(57) ABSTRACT

A method for establishing a control response between a portable control device and a controlled device is provided. The portable control device includes a touch interface for receiving control instructions. The control instructions may be issued from a user, who does not have to keep his eyes on the portable control device during control. In an embodiment, the method is applied to a portable control device to remotely control a connected TV, which may include a preview function, so that the user can control the connected TV without keeping his eyes on the portable control device. Response from a preview window on the TV can guide the user to correctly issue his control instructions from the portable control device. The control instructions can be issued by, for example, contacting the touch interface or sliding the touch interface.

### CROSS-REFERENCE TO RELATED APPLICATION

This application claims the priority benefit of Taiwan application serial no. 99146383, filed Dec. 28, 2010. The entirety of the above-mentioned patent application is hereby incorporated by reference herein and made a part of this specification.

### TECHNICAL FIELD

The disclosure relates to a method for controlling multimedia playing by using a touchscreen mobile device.

### BACKGROUND

On the CES show in early 2009, new-generation TVs with networking capacity were disclosed by various appliance manufacturers. In addition to maintaining a high hardware quality, diversified contents are further brought in through external Internet connection, so that the function of TV applications is improved. A more profuse interaction and control mechanism is provided by connecting TVs with the Internet.

In recent years, along with the widespread of smart phones (iPhone, Android phone, etc.) and notebook computers, mobile devices has been broadly accepted by consumers, which has further driven the hardware system to be continuously upgraded and software to be diversified. Early control software controls computers. Along with the rise of connected TV, mobile devices have been endowed with the capability of remotely controlling TVs through network connections.

More and more mobile devices are equipped with touch screens, while the corresponding applications are installed to the mobile devices such that users are allowed to control remote devices. However, when a user uses a touch screen as a remote control, due to the lack of sensation of physical buttons, the user has to look down at the buttons on the device to operate it but cannot perform the desired operations by simply touching the device.

### SUMMARY

A control system and a control method are introduced herein. The control system includes a portable control device and a controlled device. The portable control device includes a touch screen. The portable control device generates a first command in response to a contact and generates a second command in response to a motion associated with the contact, wherein the motion is corresponding to a gesture. The controlled device establishes a communication channel with the portable control device. When the controlled device receives the first command from the portable control device, the controlled device changes a system parameter to a first system parameter according to the first command. When the controlled device receives the second command, the controlled device changes the first system parameter to a second system parameter according to the second command.

In addition, the portable control device displays a user interface on the touch screen. The user interface includes a plurality of numerical graphical user interface (GUI) components arranged in a pattern. The first command is generated when one of the numerical GUI components is contacted.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic block diagram of a system for browsing images on a display screen of a multimedia device according to an embodiment of the disclosure.

FIG. 2 is a flowchart of a control method between a control end and a controlled end.

FIG. 3 is a flowchart of a visually cuing stage of a control method between a control end and a controlled end.

FIG. 4 is a flowchart of a user selection stage of a control method between a control end and a controlled end.

FIG. 5 is a diagram illustrating how to select a TV channel by using a mobile device.

FIG. 6A is a diagram of a user interface displayed in a mobile device.

FIG. 6B is a diagram illustrating the ranges of possible gestures on a user interface of a mobile device.

FIG. 7A and FIG. 7B are diagrams illustrating how to control the display of a TV by using a mobile device according to an embodiment of the disclosure.

### DETAILED DESCRIPTION OF DISCLOSED EMBODIMENTS

The disclosure provides a method for controlling multimedia playing by using a touchscreen mobile device, in which a user can intuitionally and remotely select a channel without looking at or staring at the remote control interface.

The disclosure provides a method suitable for a preview mechanism of a TV capable of network connection and operated with a mobile device remote control end. Such a mechanism allows a user to enjoy both the flexibility of function expansion brought by the remote control interface and the convenience of operation without looking at the remote control interface. Besides, the divisional touch control makes user operations quicker and more convenient, and the method in the disclosure can be applied to a connected TV system.

In an embodiment, the user can operate a TV without looking at the touch screen of a mobile device. Numerical graphical user interface (GUI) components are displayed on the touch screen of the mobile device. When the mobile device receives a contact, it displays changing numbers on the touch screen and issues different command to the controlled device (for example, a connected TV) according to the contacted area, so that the touched area can be visually indicated. When a motion is received right after foregoing contact, the mobile device sends a corresponding numerical selection command to the connected TV, and the connected TV responds according to the received numerical parameter, wherein the motion is corresponding to a gesture.

In an embodiment, a contact may be generated when the user touches the touch screen of the mobile device with his finger or any other tool, and a motion may be generated when the user slides his finger within an area on the touch screen after the user's finger touches the touch screen. The user can make the mobile device to sense a gesture from the touch screen so as to obtain information of the motion. Namely, corresponding gesture information is generated according to the motion. Information other than the direction can be obtained from the gesture. For example, the rolling speed of a virtual scroll wheel is adjusted according to the speed of the user's motion. The controlled device responds differently when it receives the command. For example, a faster user's motion results in a faster the field switching effect on the TV.

In the method of adjusting TV settings on a mobile device provided by the present embodiment, the user can set values for controlling the TV through the touch screen of a mobile device.

Regarding application programs on the mobile device, most existing remote control TV application programs use virtual button user interfaces. A virtual button user interface is similar to a conventional physical remote control. Accordingly, a user needs not to learn how to use the user interface. However, due to the lack of sensation of physical buttons, the user has to look at the touch screen in order to operation the mobile device, which is very inconvenient.

Regarding the control feedback of a connected TV, presently, a channel number and the title of the program played in the channel are displayed, but the content of the currently played program cannot be obtained.

The present embodiment provides a method of controlling a TV by using a touchscreen mobile device. With numerical GUI components displayed on the touch panel of the mobile device and a connected TV that can receive a numerical selection command, visual cueof a touch area is provided on the TV so that a user can quickly change TV settings without having to look at both the mobile device and the TV set.

The method for controlling a TV by using a touchscreen mobile device provided by the present embodiment includes (1) representing different numerical digits by using numerical GUI components arranged in a numerical pattern so as to quickly switch the numerical values; (2) when a numerical selection area on the mobile device is touched, prompting the user about the selected numerical digit on the TV; (3) prompting the user about the currently selected channel by using the selected numerical GUI component; and (4) displaying a preview image or an information feedback on the TV.

In the present embodiment, the mobile device generates a first command in response to a contact. For example, the first command is generated when a user touches the touch screen of the mobile device. The mobile device generates a second command in response to a motion associated with the contact, in which the motion is corresponding to a gesture. For example, the second command is generated according to a gesture corresponding to a motion with a plurality of touch areas. A controlled device (for example, a TV) establishes a communication channel with the mobile device, and when the controlled device receives the first command from the mobile device, the controlled device changes a system parameter to a first system parameter according to the first command. For example, the TV synchronously generates a visual or acoustic prompting to notify the user which digit is currently controlled. When the controlled device receives the second command, the controlled device changes the first system parameter to a second system parameter according to the second command. For example, the TV shows a preview image or information feedback to the user.

In an implementation, three numerical GUI components respectively representing a hundreds digit, a tens digit, and a units digit are displayed on the touch screen. When the user is about to select a channel, the user moves his hand to a corresponding position. Once at least one of the fingers of the user contacts the screen, the mobile device issues a command corresponding to the contacted area to the TV. The TV synchronously generates an acoustic or visual prompting to notify the user which digit is currently controlled. When the user slides his finger within a specific touch area, a corresponding numerical variation is sent to the TV. Then, the TV changes the controlled digit. For example, a preview of the channel is displayed on the TV.

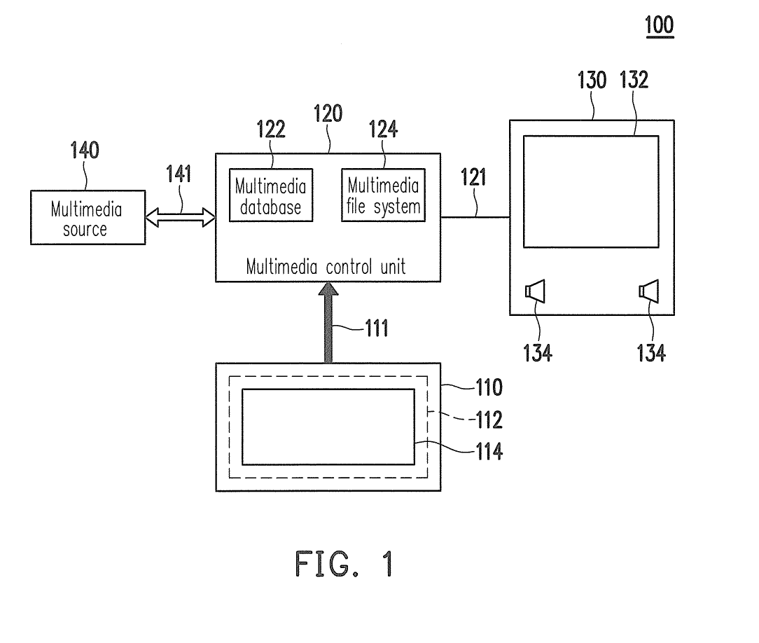

FIG. 1 is a schematic block diagram of a system for browsing images on a display screen of a multimedia device according to an embodiment of the disclosure. Referring to FIG. 1, the multimedia image browsing system 100 includes a mobile device 110 and a multimedia control unit 120. The multimedia control unit 120 has a multimedia database 122 and a multimedia file system 124. The multimedia control unit 120 respectively establishes a communication channel with a multimedia play device 130 and a multimedia source 140. The multimedia play device 130 includes a display screen 132 and a multimedia speaker 134. The communication channel between the multimedia control unit 120 and the multimedia source 140 or between the multimedia control unit 120 and the multimedia play device 130 may be used for transmitting or receiving multimedia information. The communication channel may be established through wireless communication, coaxial cable, or any other wireless or wired connection. The display screen 132 of the multimedia play device 130 displays the image of a multimedia file, and the multimedia speaker 134 plays the sound of the multimedia file.

According to an embodiment of the disclosure (but not limited thereto), the mobile device 110 includes a touch screen 112 for displaying a user interface 114. The user interface 114 includes a plurality of numerical GUI components arranged in a pattern. The user interface 114 can generate a command 111 according to a user input and sends the command 111 to the multimedia control unit 120, in which the command 111 is a command containing a numerical value. The multimedia file is from the multimedia database 122 or the multimedia source 140. The multimedia control unit 120 controls the multimedia play device 130 (for example, the image displayed on the display screen 132) according to the command 111 issued by the mobile device 110. The command 111 is a control command based on a signal generated according to the moving direction or displacement on the touch screen 112 when a user touches the touch screen 112.

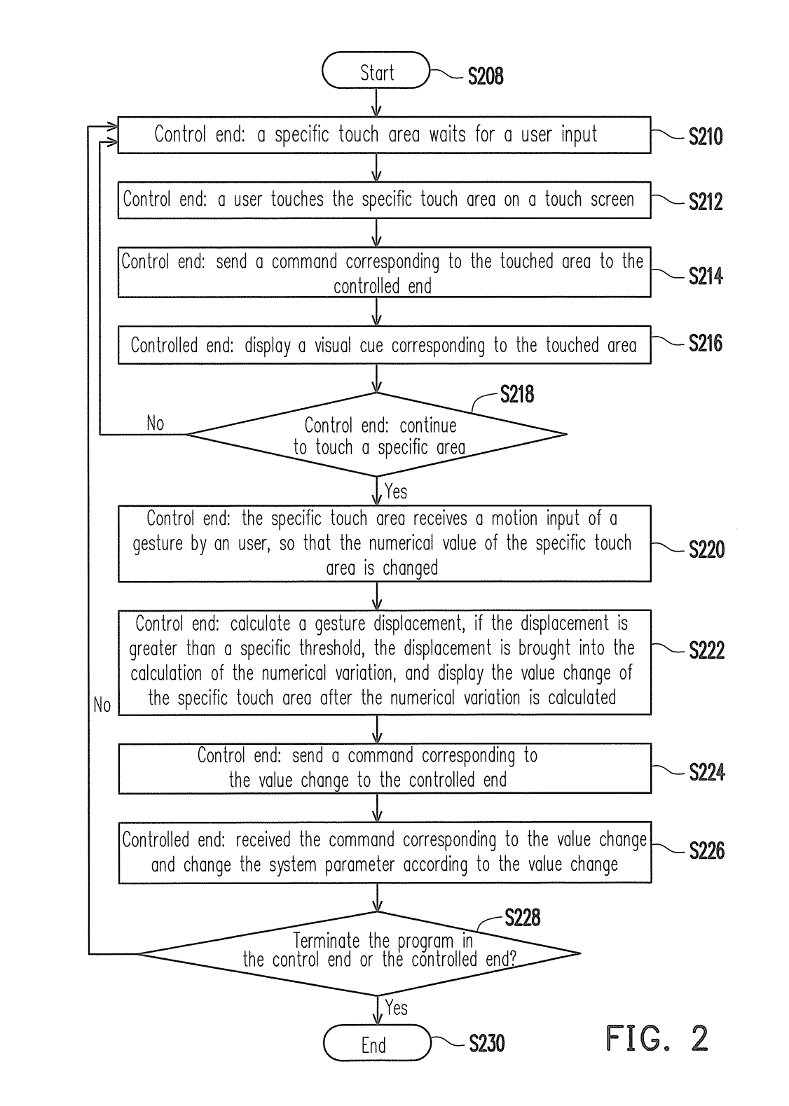

FIG. 2 is a flowchart of a control method between a control end and a controlled end. This flowchart is only an embodiment of the disclosure, and the reference numerals of following steps in the control method are not intended to limiting the sequence of these steps in the present embodiment. Referring to FIG. 2, in step S210, the control end has a specific touch area waiting for a user input. In step S212, a user touches the specific touch area on the touch screen. In step S214, the control end sends a command corresponding to the specific touch area touched by the user to the controlled end. In step S216, the controlled end receives the numerical value corresponding to the numerical GUI component of the specific area and displays a visual cue corresponding to the numerical value (the touched area).

In step S218, whether the user continues to touch the specific touch area is determined. If the user stops touching this area, the procedure returns to step S210 to wait for next user input. If the user continues to touch the specific touch area, in step S220, the control end determines the gesture of the user and associates the specific touch area with the gesture, so as to generate a parameter variation, such as a numerical variation. In step S222, the control end calculates the displacement of the gesture. If the displacement is greater than a specific predetermined threshold, the displacement is brought into the calculation of the numerical variation. After the numerical variation is calculated, the numerical variation of the specific touch area is displayed. In step S224, the control end issues a numerical variation command to the controlled end. In step S226, after the controlled end receives the numerical variation command, it changes the settings. In step S228, whether to terminate the program of the control end or the controlled end is determined. If so, the procedure ends here. For example, whether any contact or sliding operation is received is detected within a specific time period. If the program of the control end or the controlled end is not to be terminated, the procedure returns to step S218 to determine whether the user continuous to touch the specific touch area.

Below, the control method between a control end and a controlled end will be described by taking a mobile device with a touch screen and a TV set as an example.

During a visualized cuing stage, when the user starts the control software in the mobile device, the software (remote control function) of the mobile device is executed. A gesture input signal within a specific area of the touch screen is received, and numerical GUI components (for example, a virtual scroll wheel) for numerical value section are displayed in the specific area. After the user touches the specific area, the program receives an input event from the system, and information (for example, number of digits) of the input area is calculated and sent to the controlled end (the connected TV). After the controlled end receives the information, it displays a visual cue (for example, the color of a specific digit is changed) so that the user can remotely change settings of the controlled end by touching the control interface without looking at the interface of the control end. During an initial control stage, the user is notified that he can control the channels by displaying a visual cue on the TV.

During a user selection stage, if the user changes the numerical value of the numerical GUI component by a sliding gesture, the control end issues a numerical change command to the controlled end. After receiving the command, the controlled end instantly changes the settings (for example, switches the channels) and displays the preview or electronic program guides (EPG) information of a specific channel, so that the user can precisely control the channels by referring to such information.

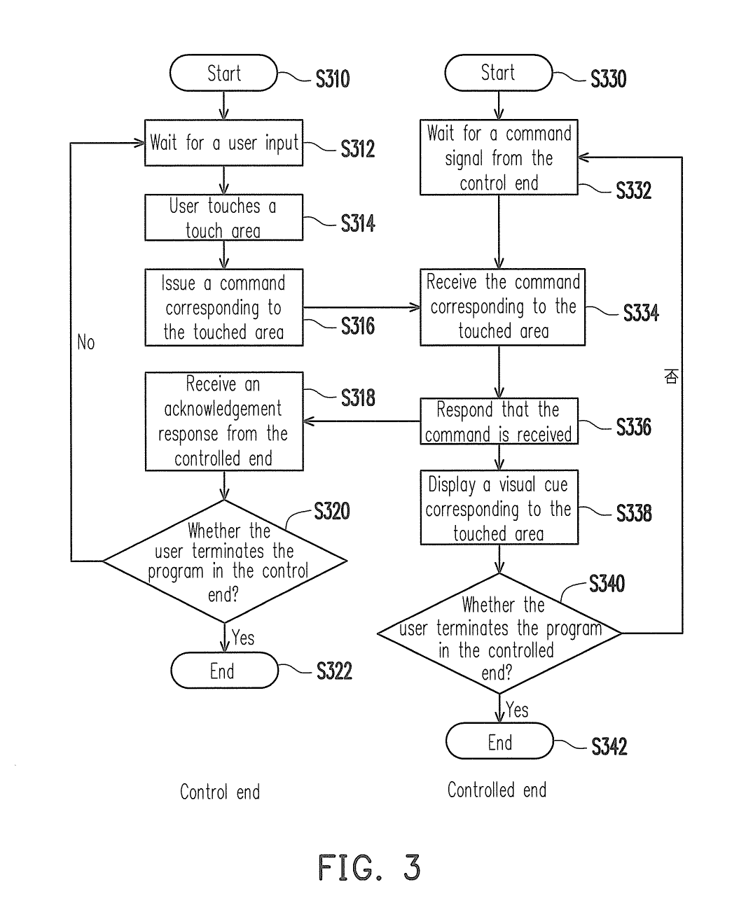

FIG. 3 is a flowchart of a visually cuing stage of a control method between a control end and a controlled end. The visually cuing stage is an embodiment of the disclosure, and the reference numerals of following steps in the control method are not intended to limiting the sequence of these steps in the present embodiment. During the visually cuing stage, the controlled end displays the visual cue (for example, color changing of a specific digit) so that the user can remotely change the settings of the controlled end by touching the control interface without looking at the interface of the control end.

At the control end, the user executes software in the mobile device. If the controlled device is already turned on, step S332 is instantly executed to wait for a command signal from the control end. The controlled device may be a TV, and the images displayed on the TV should still be normal TV output (i.e., no channel selection preview menu is displayed yet). In step S312, the control end waits for a user input within a specific touch area. Once the controlled end enters a controlled state, in step S332, it waits for a command signal from the control end.

In step S314, the user touches the specific touch area on the touch screen. In step S316, the control end issues a command corresponding to the specific touch area touched by the user to the controlled end. In step S334, the controlled end receives this command, wherein the digit to be controlled may be the tens digit or the hundreds digit of a numerical value. In step S336, the controlled end responds the control end that it receives the command corresponding to the specific touch area. In step S318, the control end receives the response from the controlled end. In step S320, the control end determines whether the user terminates the program in the control end. If so, the procedure ends in step S322. Otherwise, the procedure returns to step S312 to wait for another user input.

After the controlled end responds the control end that it receives the command corresponding to the specific touch area, step S338 is executed, wherein a visual cue corresponding to the command that is issued when a specific touch area is contacted is displayed. The visual cue may be color changing or flashing effect of the channel number, and which is displayed in order to notify the user that a channel selection status has been entered.

The mobile device executes a software program and waits for receiving a gesture input within a specific area on the touch screen. Herein a corresponding numerical GUI component for numerical selection is shown in each specific area. When the user contacts a specific area, the program receives an input event from the system and calculates the specific area corresponding to the contact event. In an embodiment, it is assumed that the touch event received from the system has coordinates (Xevent, Yevent), there are N specific touch areas AreaA, AreaB, . . . , and AreaN, and the top left corner and bottom right corner of the touched area K respectively have coordinates (XKLeftop, YKLefttop) and (XKRightbottom, YKRightbottom).

Condition one: XKleftop<Xevent and YKlefttop<Yevent

Condition two: XKRightbottom>Xevent and YKRightbottom>Yevent

When the two conditions are both satisfied, it is determined that the contact event occurs within the K^{th} specific area.

After obtaining the currently touched area through the technique described above, the mobile device sends the information of the specific numerical digit corresponding to the touch area to the controlled end. After receiving the information, the controlled end displays a visual cue and changes the color of the specific digit (or highlights or flashes the specific digit, etc) in order to allow the user to view and determine the currently controlled numerical digit.

After the user selection stage is entered, if the user changes the value of a numerical GUI component through a sliding gesture, the mobile device issues a numerical change command to the controlled end. After receiving this command, the controlled end instantly changes the settings (for example, switches the channels) and displays the preview image or EPG information of a specific channel, so that the user can precisely control the channel switching by referring to foregoing information.

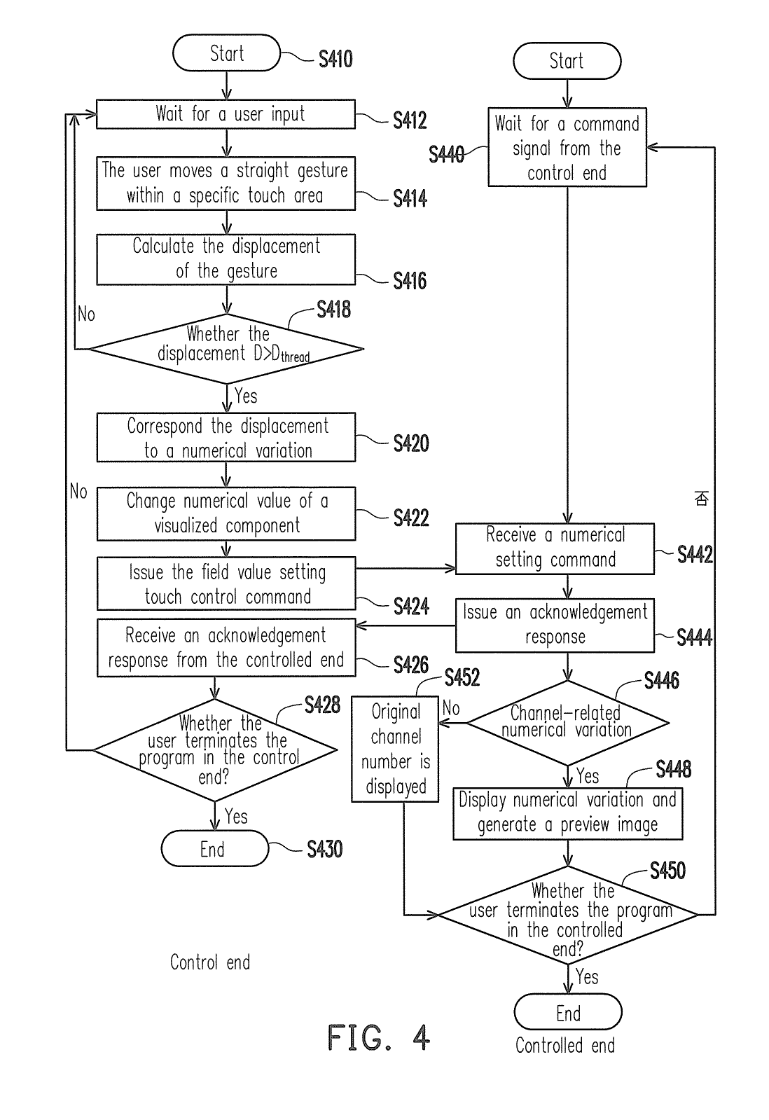

FIG. 4 is a flowchart of a user selection stage of a control method between a control end and a controlled end. The user selection stage is only an embodiment of the disclosure, and the reference numerals of following steps in the control method are not intended to limiting the sequence of these steps in the present embodiment.

In step S410, the user enters a control stage (for example, a channel switching status of the TV), and in step S412, a user input is waited for. Meanwhile, in step S440, the controlled end also enters a status for receiving command signals from the control end. In step S414, the user moves within a specific touch area to produce a straight moving gesture event. In step S416, the displacement of the gesture is calculated, and in step S418, whether the displacement D is greater than a predetermined threshold D_{thread} is determined. If the displacement D is not greater than the predetermined threshold D_{thread}, the procedure returns to step S412 to wait for another user input. If the displacement D is greater than the predetermined threshold D_{thread}, step S420 is executed, wherein the numerical value of the command is changed according to the displacement (i.e., a numerical variation is generated in response to the displacement). Next, in step S422, the value of the numerical GUI component corresponding to the touched area is changed according to the numerical variation. In step S424, the new value of the numerical GUI component is sent to the controlled end.

After the controlled end receives the numerical setting command (containing the new value of the numerical GUI component corresponding to the touched area), it first responds to the control end that the command is already received, as in steps S442 and S444. After the control end receives the acknowledge response from the controlled end, the control end determines whether the user terminates the program in the control end, as in steps S426 and S428. If the user terminates the program in the control end, the procedure ends at step S430. Otherwise, the procedure returns to step S412 to wait for another user input.

After the controlled end responds to the control end that the command is already received, in step S446, whether the numerical value of the channel changes. If the numerical value of the channel does not change, in step S452, the original channel number is displayed. After that, in step S450, whether the user terminates the program in the control end is determined. If the numerical value of the channel changes, in step S448, the new value and a preview image are displayed on TV. Next, in step S450, the controlled end determines whether the user terminates the program in the control end. If so, the procedure ends herein. Otherwise, the procedure returns to step S440 to wait for a command from the control end.

When the user determines the numerical digit to be operated, the user slides on the touch screen to drive the numerical GUI component of numerical selection. If the displacement D of the input gesture is greater than a predetermined threshold D_{thread}), it is determined that the user input is not a mistake. The mobile device sends the numerical variation of the numerical GUI component corresponding to the input event to the controlled end through a numerical variation command of the specific digit. After the controlled end receives the numerical variation command, it changes settings associated with the channel or volume. Because the specific field of the user contact has been obtained during a visual cue processing stage, the value of the field corresponding to the subsequent sliding gesture can be instantly and conveniently changed in a value setting menu of the controlled end.

Below, a method of selecting a TV channel by using a mobile device will be described with reference to an embodiment of the disclosure.

An application program is installed in the mobile device, and an input event is obtained through the touch screen. When a user contacts the touch screen, a command is sent to the controlled end according to the touched position, so as to generate a cue. Regardless of whether the cue is a visual cue or an acoustic cue, it allows the user to understand which digit in the controlled end the touched area represents. Next, when the user slides his finger within a specific area of the touch screen, the application program receives a gesture input displacement and calculates the value currently selected by the user after the displacement is calculated. After that, the application program sends the value to the TV through a wireless connection.

In the method for controlling a TV by using a mobile device provided by the present embodiment, different digits of a numerical value are represented by numerical GUI components of a plurality of touch areas, so as to change the numerical value quickly. When a user touches a numerical selection area in the mobile device, the TV notifies the user the selected digit of the numerical value. The mobile device notifies the user about the currently selected channel by using the numerical GUI components. The TV displays a preview image or information feedback to the user.

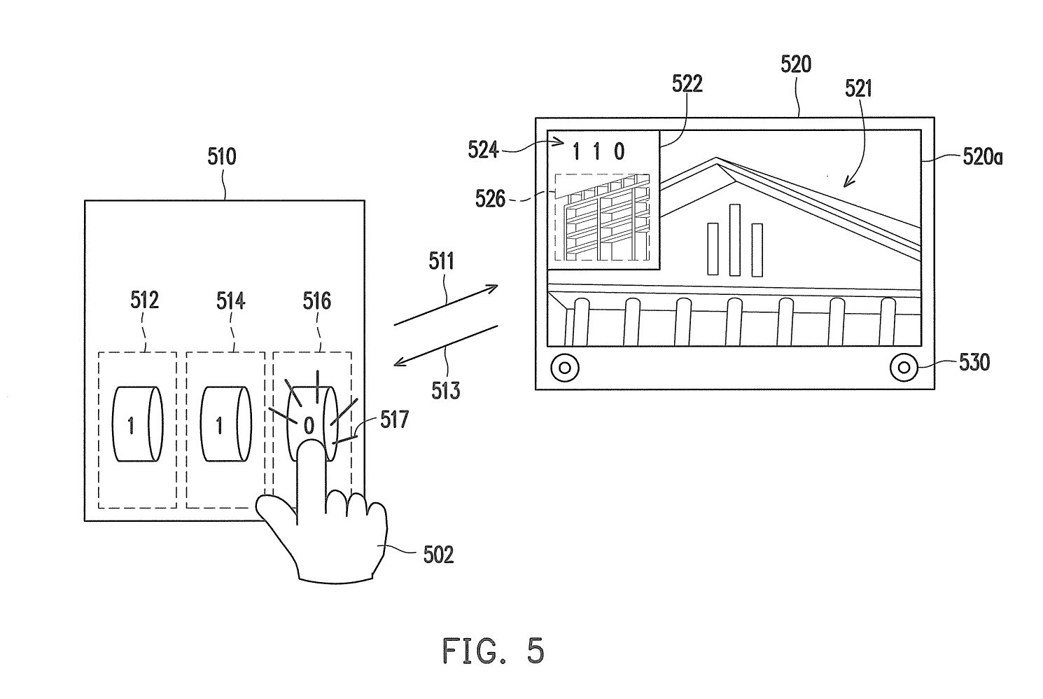

FIG. 5 is a diagram illustrating how to select a TV channel by using a mobile device. The mobile device 510 has an application program and displays a scroll wheel display interface (as shown in FIG. 5) to obtain an input event of the touch screen. To be specific, when the application program of the mobile device 510 is executed, numerical GUI components 512, 514, and 516 respectively representing a hundreds digit, a tens digit, and a units digit of a numerical value are displayed on the touch screen.

When the user is about to select a channel, the user moves his hand 502 to a corresponding position. Once the hand 502 touches the screen, the mobile device 510 issues a command 511 corresponding to the touched area to the TV 520. A display unit 520a of the TV 520 sends an acknowledge signal 513 to the mobile device 510.

The TV 520 synchronously generates an acoustic and a visual feedback to the user to notify the user which digit is currently controlled. For example, in the present embodiment, the display unit 520a of the TV 520 already displays a main menu 521 and a preview menu 522. The preview menu 522 contains a channel number 524 and a preview image 526. The channel number 524 is, same as the channel number currently displayed in the mobile device 510, “110”.

When the hand 502 touches the area corresponding to the numerical GUI component 516 (i.e., the units digit is to be changed), the preview menu 522 on the TV 520 generates a visual cue (for example, changes the color of the units digit “0” or flashes it). When the user slides his hand 502 up and down within the area corresponding to the numerical GUI component 516 (for example, in the gesture direction 517 in FIG. 5), the application program receives a gesture input displacement and calculates the value currently selected by the user after the displacement occurs. Then, the application program sends the value to the TV 520. Herein if the displacement is “+1”, the preview menu 522 on the TV 520 shows the content of a channel with a channel number of “111”, and meanwhile, the channel number on the mobile device 510 is also changed to “111”. If the displacement is “−1”, the preview menu 522 on the TV 520 shows the content of a channel with a channel number of “109”, and meanwhile, the channel number on the mobile device 510 is also changed to “109”.

When the hand 502 touches an area corresponding to the numerical GUI component 514 (i.e., the tens digit is to be changed), the tens digit of the channel number “110” displayed in the preview menu 522 changes it color or flashes. When the user slides his hand 502 up and down within the area corresponding to the numerical GUI component 514, the tens digit of the channel number 524 displayed in the preview menu 522 changes with the sliding gesture of the user.

Regarding the response to the control operation, in an embodiment, the TV 520 may also synchronously generate an acoustic feedback to the user. For example, the TV 520 includes a sound generation unit 530. When the TV 520 receives a control command from a control device, the TV 520 issues an acoustic cue to the user through the sound generation unit 530.

The control method by using a touchscreen mobile device provided by the disclosure may also be applied to controlling channel selection of a connected TV by using a mobile device.

A connected TV is a TV with IP connection. The connected TV is connected to a program service end through the IP connection to obtain program stream files or multimedia files, or even EPG information. The connected TV has a program for receiving numerical parameters from an application program of a mobile device, generating a cue corresponding to a field or changing the channel or volume of the TV according to a numerical field or a value changing command received from the control end (mobile device) through the network, and displaying a preview image on the screen of the TV according to the numerical parameters.

In the present embodiment, the mobile device sends a command to the connected TV through the network. Thereby, the IP address of the controlled end (i.e., the connected TV) should be obtained in advance. The IP address can be determined by the user or obtained by inquiring adjoining IP addresses through program broadcasting.

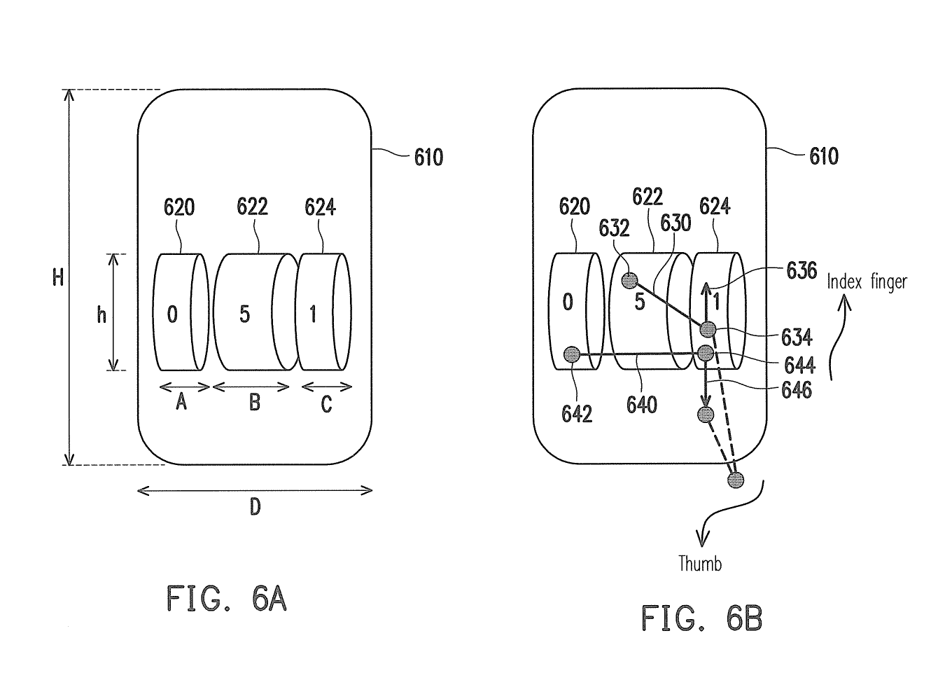

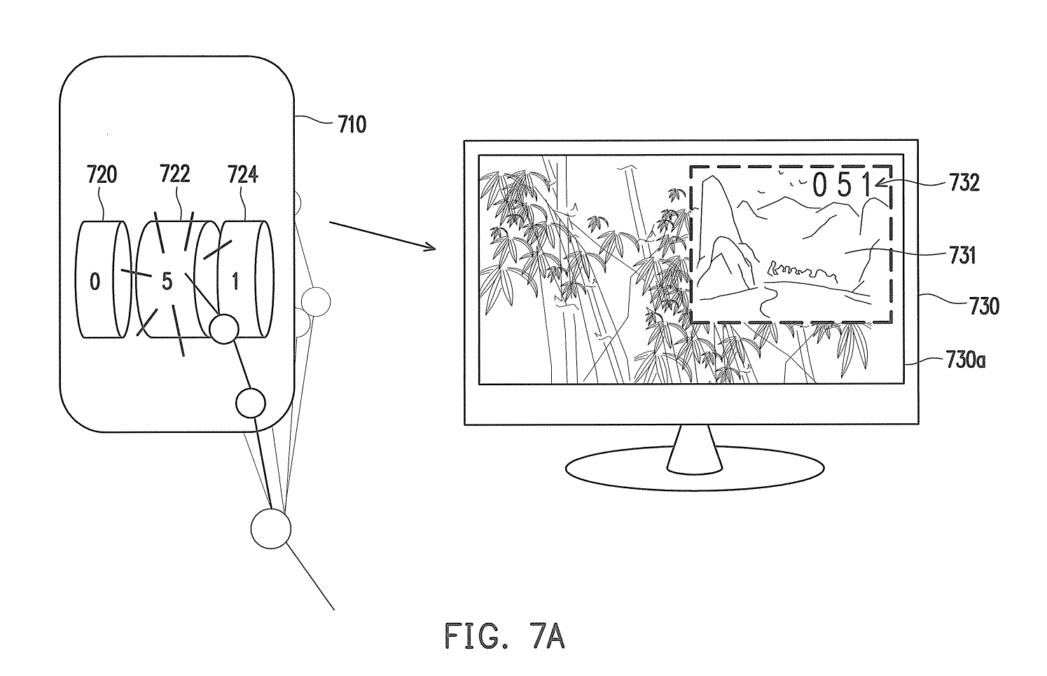

FIG. 6A is a diagram of a user interface displayed in a mobile device. The application program installed in the mobile device 610 may display a scroll wheel interface and a plurality of numerical GUI components on the touch screen. Regarding the layout of the entire user interface, if there are two numerical GUI components, the two numerical GUI components have the same width, or the more frequently used numerical GUI component (for example, the numerical GUI component corresponding to the units digit) has a greater width. If there are three or more numerical GUI components, the one in the middle has a greater width than the numerical GUI components at sides.

For example, the three numerical GUI components 620, 622, and 624 in FIG. 6A respectively represent a hundreds digit, a tens digit, and a units digit. The numerical GUI component 622 is displayed to the left of the numerical GUI component 624, and the numerical GUI component 620 is displayed to the left of the numerical GUI component 622. The width of the entire user interface is D, and the widths of the numerical GUI components 620, 622, and 624 are respectively A, B, and C. On the user interface, the width B of the numerical GUI component 622 is greater than or equal to the widths A and C of the numerical GUI component 620 and 624. In an embodiment, B≧A or B≧C, and B is between a quarter of D and half of D (i.e., D/2≧B≧D/4).

Regarding the height of the area for sensing the user's gesture, if the height of the touch screen is H, the heights of the sensing areas respectively corresponding to the numerical GUI components 620, 622, and 624 are respectively h, and h is between a quarter of H and half of H (i.e., H/2≧h≧H/4).

FIG. 6B is a diagram illustrating the ranges of possible gestures on a user interface of a mobile device. When a channel is selected on the numerical GUI components 620, 622, and 624 displayed in the scroll wheel interface, different gestures may be used to allow the application program of the mobile device 610 to sense which numerical GUI component is selected and how to switch the channel. Referring to the moving trail 630 in FIG. 6B, the thumb triggers the control procedure on the numerical GUI component 622 (the touch point 632), then moves to the numerical GUI component 624 (the touch point 634), and eventually performs an upwards gesture 636 to switch the channel. Referring to the moving trail 640, the thumb triggers the control procedure on the numerical GUI component 620 (the touch point 642), then moves to the numerical GUI component 624 (the touch point 644), and eventually perform is a downwards gesture 646 to switch the channel.

The distance between the numerical GUI components 620, 622, and 624 on the scroll wheel interface can be adjusted according to different design. In an embodiment, the distance between different control areas is greater than 0.1 cm.

If the user holds and operates the mobile device 610 with a single hand, in an embodiment, the distance between different control areas should be smaller than 0.57 cm and greater than 0.105 cm.

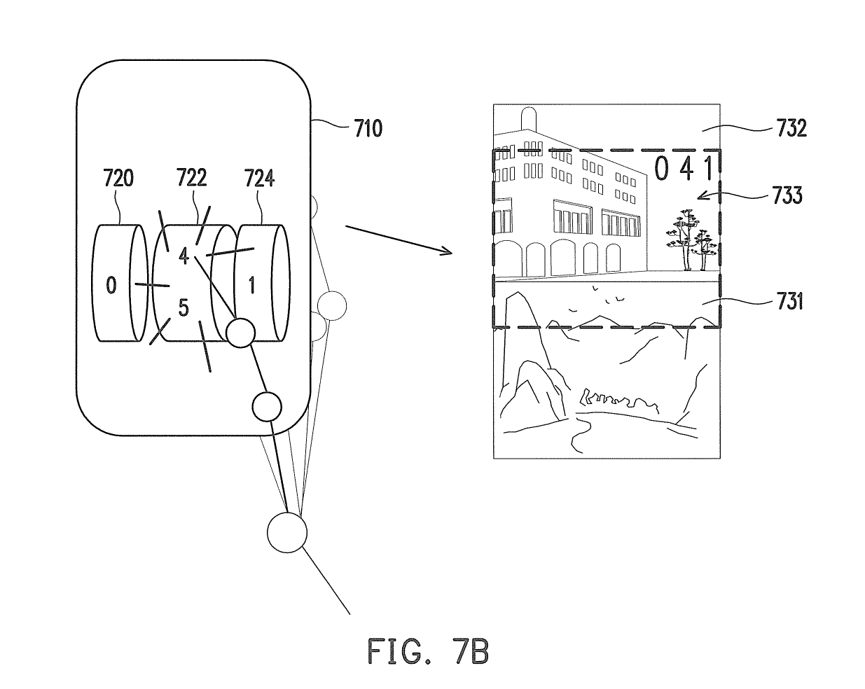

FIG. 7A and FIG. 7B are diagrams illustrating how to control the display of a TV by using a mobile device according to an embodiment of the disclosure. Different digits of a numerical value are represented by using numerical GUI components corresponding to a plurality of touch areas, so that the numerical value can be changed instantly.

FIG. 7A illustrates the scroll wheel interface displayed in the mobile device 710, wherein the scroll wheel interface has three numerical GUI components 720, 722, and 724. When a user is about to select a channel, the user moves his hand to the corresponding position and touches the screen of the mobile device 710. At this time, the display unit 730a on the display device 730 displays a preview menu 731 and a channel number 732 (for example, “051”) on the main menu.

When the user touches the area corresponding to the numerical GUI component 722 (i.e., the tens digit is to be changed), the tens digit of the channel number 732 (i.e., “051”) displayed in the preview menu 731 changes its color or flashes. When the user slides his hand up and down within the area corresponding to the numerical GUI component 722, the tens digit of the channel number “051” displayed in the preview menu 731 changes with the sliding gesture of the user. However, as shown in FIG. 7B, two images may be switched through a field switching effect. For example, part of the image of the channel 051 and part of the image of the channel 041 are both displayed in the preview menu 731 to be selected by the user. When the user speeds up the sliding gesture thereof (i.e., the scrolling speed is increased), the preview images are scrolled faster too. The image field switching effect makes the operation of the user more convenient.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A control system, comprising:
a portable control device, for generating a first command in response to a contact and generating a second command in response to a motion associated with the contact, wherein the motion is corresponding to a gesture; and
a controlled device, for establishing a communication channel with the portable control device, wherein when the controlled device receives the first command from the portable control device, the controlled device changes a system parameter to a first system parameter according to the first command, and when the controlled device receives the second command, the controlled device changes the first system parameter to a second system parameter according to the second command.

2. The control system according to claim 1, wherein the portable control device comprises a touch screen, and a user interface is displayed on the touch screen, wherein the user interface comprises a plurality of graphical user interface (GUI) components arranged in a pattern, and the first command is generated when an area on the touch screen that is corresponding to one of the GUI components is contacted.

3. The control system according to claim 2, wherein the GUI components of the control system are arranged in a numerical manner, a first group of the GUI components represent a units digit of a numerical value, a second group of the GUI components represent a tens digit of the numerical value, and the second group of GUI components is displayed to the left of the first group of GUI components.

4. The control system according to claim 2, wherein the GUI components are arranged in a numerical manner, a first group of the GUI components represent a units digit of a numerical value, a second group of the GUI components represent a tens digit of the numerical value, a third group of the GUI components represent a hundreds digit of the numerical value, the second group of GUI components is displayed to the left of the first group of GUI components, and the third group of GUI components is displayed to the left of the second group of GUI components.

5. The control system according to claim 2, wherein one of the GUI components sends a numerical variation corresponding to the gesture back to the controlled device, so as to generate the second system parameter.

6. The control system according to claim 2, wherein the controlled device comprises a display unit, and when the controlled device receives the first command from the portable control device and generates the first system parameter according to the first command, the controlled device further displays an preview area within a specific area of the display unit, wherein a visual cue corresponding to the first command is displayed within the preview area.

7. The control system according to claim 6, wherein the visual cue comprises flashing or changing a display color.

8. The control system according to claim 2, wherein the controlled device comprises a sound generation unit, and when the controlled device receives the first command from the portable control device and generates the first system parameter according to the first command, the controlled device further issues an acoustical cue.

9. The control system according to claim 2, wherein three of the GUI components are arranged side by side on the user interface, a control area width of the GUI component in the middle regarding the motion is greater than or equal to control area widths of the GUI components at two sides, and the control area widths of the GUI components at two sides are the same.

10. The control system according to claim 2, wherein three of the GUI components are arranged side by side on the user interface, a control area width of the GUI component in the middle regarding the motion is greater than or equal to a quarter of a width of the user interface and smaller than or equal to half of the width of the user interface.

11. The control system according to claim 2, wherein two of the GUI components are arranged side by side on the user interface, and control area widths of the GUI components regarding the motion are the same.

12. The control system according to claim 1, wherein the portable control device generates a displacement according to the motion and generates the second command when the displacement exceeds a predetermined threshold.

13. The control system according to claim 12, wherein the controlled device comprises a display unit, and when the system parameter is the first system parameter, the controlled device displays an preview area within a specific area of the display unit, and when the system parameter is the second system parameter, the controlled device changes a content of the preview area.

14. The control system according to claim 13, wherein a program preview image and a channel number are displayed in the preview area, and when the system parameter is the second system parameter, the program preview image and the channel number in the preview area are switched.

15. The control system according to claim 14, wherein the program preview image is an electronic program guide or a program image thumbnail.

16. A control method, adaptable to a portable control device and a controlled device, the control method comprising:
generating a first command in response to a contact, and generating a second command in response to a motion associated with the contact, wherein the motion is corresponding to a gesture; and
when the controlled device receives the first command from the portable control device, changing a system parameter to a first system parameter according to the first command, and when the controlled device receives the second command from the portable control device, changing the first system parameter to a second system parameter according to the second command.

17. The control method according to claim 16 further comprising:
displaying a user interface on a touch screen of the portable control device, wherein the user interface comprises a plurality of graphical user interface (GUI) components arranged in a pattern, and the first command is generated when an area on the touch screen that is corresponding to one of the GUI components is contacted.

18. The control method according to claim 17, wherein the GUI components are arranged in a numerical manner, a first one of the GUI components represents a units digit of a numerical value, and a second one of the GUI components represents a tens digit of the numerical value.

19. The control method according to claim 17, wherein the GUI components are arranged in a numerical manner, a first one of the GUI components represents a units digit of a numerical value, a second one of the GUI components represents a tens digit of the numerical value, and a third one of the GUI components represents a hundreds digit of the numerical value.

20. The control method according to claim 17, wherein one of the GUI components sends a numerical variation corresponding to the gesture to the controlled device, so as to generate the second system parameter.

21. The control method according to claim 17, wherein when the controlled device receives the first command from portable control device and generates the first system parameter according to the first command, a preview area is further displayed within a specific area of the controlled device, wherein a visual cue corresponding to the first command is displayed within the preview area.

22. The control method according to claim 21, wherein the visual cue comprises flashing or changing a display color.

23. The control method according to claim 17, wherein the controlled device comprises a sound generation unit, and when the controlled device receives the first command from the portable control device and generates the first system parameter according to the first command, an acoustical cue is further issued on the controlled device.

24. The control method according to claim 17, wherein three of the GUI components are arranged side by side on the user interface, a control area width of the GUI component in the middle regarding the motion is greater than or equal to control area widths of the GUI components at two sides, and the control area widths of the GUI components at two sides are the same.

25. The control method according to claim 17, wherein three of the GUI components are arranged side by side on the user interface, a control area width of the GUI component in the middle regarding the motion is greater than or equal to a quarter of a width of the user interface and smaller than or equal to half of the width of the user interface.

26. The control method according to claim 17, wherein two of the GUI components are arranged side by side on the user interface, and control area widths of the GUI components regarding the motion are the same.

27. The control method according to claim 17, wherein the motion is generated by sliding on the touch screen, a sliding displacement is recorded, and the second command is generated when the sliding displacement exceeds a predetermined threshold.

28. The control method according to claim 27, wherein when the system parameter is the first system parameter, the controlled device displays a preview area within a specific area, and when the system parameter is the second system parameter, the controlled device changes a content of the preview area.
